(19) United States
(12) Patent Application Publication
(10) Pub. No.: US 2023/0292387 A1
(43) Pub. Date: Sep. 14, 2023

(54) METHOD AND DEVICE FOR JOINTLY SERVING USER EQUIPMENT BY WIRELESS ACCESS NETWORK NODES

(71) Applicant: ZTE Corporation, Shenzhen (CN)

(72) Inventors: Li YANG, Shenzhen (CN); Guanghui YU, Shenzhen (CN); Feng XIE, Shenzhen (CN)

(73) Assignee: ZTE Corporation, Shenzhen (CN)

(21) Appl. No.: 18/199,518

(22) Filed: May 19, 2023

Related U.S. Application Data
(63) Continuation of application No. PCT/CN2020/130926, filed on Nov. 23, 2020.

(51) Int. Cl. H04W 76/15

(52) U.S. Cl. CPC H04W 76/15

(57) ABSTRACT

This disclosure relates to method and device for serving a user equipment by a first wireless network node. In one implementation, the method may include transmitting a request message for a non-radio-communication service resource of a second wireless access network node to the second wireless access network node. The first wireless access network node may provide the user equipment with a non-radio-communication service and request the non-radio-communication service resource to assist to provide the non-radio-communication service to the user equipment. The method may further include receiving a response message allocating the non-radio-communication service resource for the user equipment from the second wireless access network node.

### TECHNICAL FIELD

This disclosure is directed generally to wireless communications and particularly to jointly serving a user equipment by wireless access network nodes.

### BACKGROUND

Wireless communication technologies are moving the world toward an increasingly connected and networked society. The rapid growth of mobile communications and advances in technology have render greater demand for network service capability and connectivity. Other aspects, such as energy consumption, reliability, spectral efficiency, and latency are also important to meeting the needs of various communication scenarios. In comparison with the existing wireless access networks, next generation systems and wireless communication techniques are expected to provide user equipments (UEs) with diversified services with low latency beyond radio communication service.

### SUMMARY

This disclosure is directed to methods and device related to wireless communication, and more specifically, for jointly serving a user equipment by wireless access network nodes so as to provide the user equipments with various non-radio-communication services.

In one embodiment, a method performed by a first wireless access network node serving a user equipment in a wireless communication network is disclosed. The method may include transmitting a request message for a non-radio-communication service resource of a second wireless access network node to the second wireless access network node. The first wireless access network node may provide the user equipment with a non-radio-communication service and request the non-radio-communication service resource to assist to provide the non-radio-communication service to the user equipment. The method may further include receiving a response message allocating the non-radio-communication service resource for the user equipment from the second wireless access network node.

In another embodiment, a method performed by a second wireless access network node in a wireless communication network is disclosed. The method may include receiving a first request message for a non-radio-communication service resource of the second wireless access network node from a first wireless access network node. The first wireless access network node may provide a user equipment with both a radio communication service and a non-radio-communication service and request the non-radio-communication service resource to assist to provide the non-radio-communication service to the user equipment. The method may further include transmitting a response message allocating the non-radio-communication service resource to the first wireless access network node.

In another embodiment, a device for wireless communication may include a memory storing instructions and a processing circuitry in communication with the memory. When the processing circuitry executes the instructions, the processing circuitry is configured to carry out the above method.

In another embodiment, a computer-readable medium comprising instructions which, when executed by a computer, cause the computer to carry out the above method.

The above and other aspects and their implementations are described in greater detail in the drawings, the descriptions, and the claims below.

### BRIEF DESCRIPTION OF THE DRAWINGS

FIG. 1 illustrates an exemplary cellular wireless access network in accordance with various embodiments.

FIG. 2 illustrates an exemplary diagram illustrating communication between the wireless access network nodes in the wireless access network.

FIG. 3A-3B illustrate an exemplary architecture model of dual connectivity.

FIG. 4 illustrates a flow diagram of a method for serving a UE in accordance with an embodiment.

FIG. 5 illustrates a flow diagram of a method for serving a UE in accordance with an embodiment.

FIG. 6 illustrates a flow diagram of a method for serving a UE in accordance with an embodiment.

FIG. 7 illustrates a flow diagram of a method for serving a UE in accordance with an embodiment.

FIG. 8 illustrates a flow diagram of a method for serving a UE in accordance with an embodiment.

FIG. 9 illustrates a flow diagram of a method for serving a UE in accordance with an embodiment.

FIG. 10 illustrates a flow diagram of a method for serving a UE in accordance with an embodiment.

### DETAILED DESCRIPTION

The technology and examples of implementations and/or embodiments in this disclosure can be used to improve performance in wireless communication systems. The term “exemplary” is used to mean “an example of” and unless otherwise stated, does not imply an ideal or preferred example, implementation, or embodiment. Please note that the implementations may, however, be embodied in a variety of different forms and, therefore, the covered or claimed subject matter is intended to be construed as not being limited to any of the embodiments to be set forth below. Please also note that the implementations may be embodied as methods, devices, components, or systems. Accordingly, embodiments of this disclosure may, for example, take the form of hardware, software, firmware or any combination thereof.

A wireless access network typically provides radio link and backhaul connectivity between a user equipment and an information or data network such as a voice or video communication network, the Internet, and the like. An example wireless access network may be based on cellular technologies, which may further be based on, for example, 5G NR technologies and/or Radio Access Type. In cellular wireless access network, multiple wireless access network nodes (WANNs) of same or different radio access technologies (RATs), e.g. eNB, en-gNB, ng-eNB, gNB, may be deployed in different frequency carriers but for the same geographic coverage areas. They can inter-work with each other via specified dual connectivity (DC)/ multiple connectivity (MC) operation to provide joint radio communication service for target UE(s).

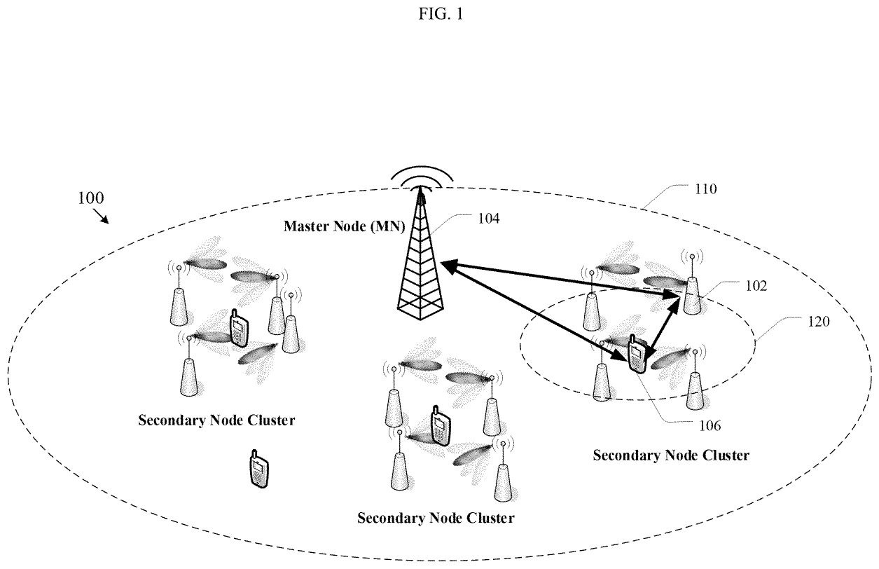

FIG. 1 illustrates an exemplary cellular wireless access network 100 according to various embodiments. In the network 100, one macro WANN 104, also referred to as master node (MN), may provide a large coverage with macro cell 110, while some micro WANNs 102, also referred to as secondary node (SN) may provide overlapped small coverage with micro cells 120. The UE 106 can be configured and served by the MN 104 and the SN 102 jointly so as to boost its user data peak rate/throughput, radio link reliability, etc. When the UE 106 moves around the SN clusters, its serving SN(s) gets changed accordingly based on the radio quality of the micro cell. From UE perspective, it is provided with the joint radio communication service among multiple WANNs. The UE 202 may include but is not limited to a mobile phone, smartphone, tablet, laptop computer, a smart electronics, a wearable device, a video surveillance device, an industrial wireless sensors, or appliance including an air conditioner, a television, a refrigerator, an oven and the like, or other devices that are capable of communicating wirelessly over a network.

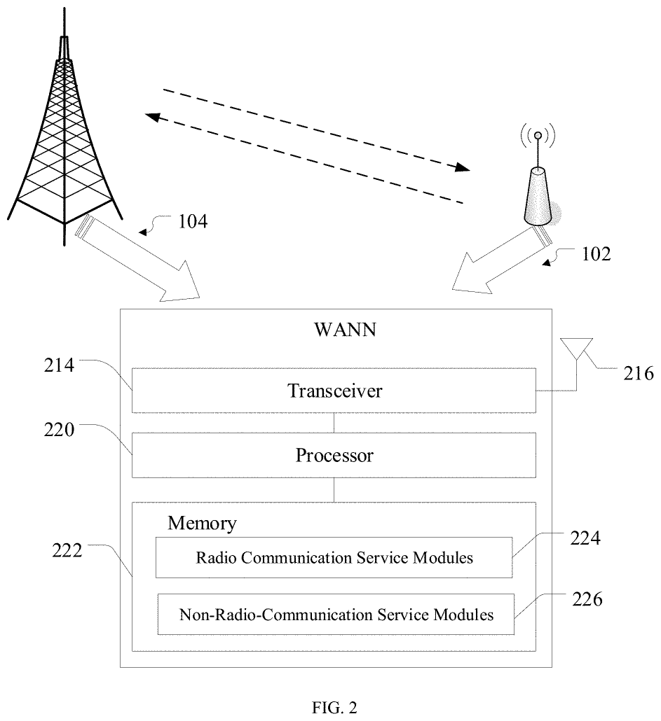

FIG. 2 shows an exemplary system diagram illustrating communication between the MN 104 and the SN 102 in the wireless access network 100. The WANNs in the wireless access network 100 may be configured to perform a corresponding set of wireless network functions. The set of wireless network functions, capabilities, resources between different types of wireless access network nodes may not be identical. The set of wireless network functions, capabilities, resources between different types of wireless access network nodes, however, may overlap to some extent.

Take the MN 104 and the SN 102 as example, each of them may include transceiver circuitry 214 coupled to one or more antennas 216 to effect wireless communication with the UE 202. The transceiver circuitry 214 may also be coupled to one or more processors 220, which may also be coupled to a memory 222 or other storage devices. The memory 222 may store therein the radio communication service modules 224 that, when read and executed by the processor 220, cause the processor 220 to implement radio communication services such as the radio access for UEs, data transmission between UEs, etc. The memory 222 may also store therein the non-radio-communication service modules 226 that, when read and executed by the processor 220, cause the processor 220 to implement non-radio-communication services provided to UEs such as computing assisting service, intelligence assisting service, storage assisting service, etc. The memory 222 may also store therein instructions or code that, when read and executed by the processor 220, cause the processor 220 to implement various ones of the methods described herein. The MN 104 and the SN 102 may have a direct or indirect communication interface in-between for information coordination. The direct communication interface may be implemented in a wireline such as fiber or wireless way. In addition, while various embodiments will be discussed in the context of the particular example wireless communication network 100, the underlying principle applies to other applicable wireless communication networks.

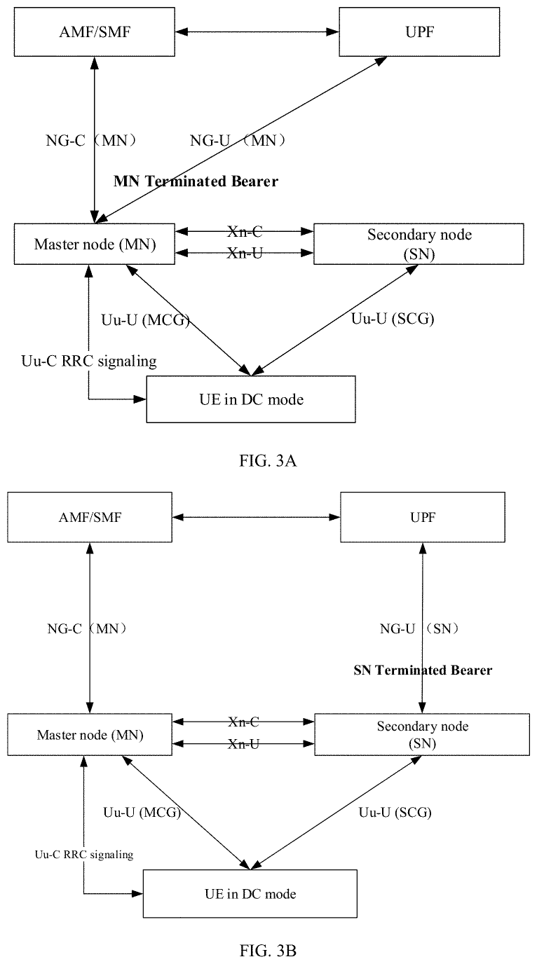

For purpose of conceptual illustration, an exemplary architecture model of dual connectivity is shown in FIGS. 3A and 3B. Access Mobility Function/Session Management Function (AMF/SMF) are control plane entities in 5G Core (5GC) and User Plane Function (UPF) is user plane entity in 5GC. The signaling connection between the AMF/SMF and the MN is Next Generation—Control Plane (NG-C) (MN) interface instance. The signaling connection between MN and SN is Xn-Control Plane (Xn-C) interface instance. The signaling connection between MN and UE is Uu-Control Plane (Uu-C) Radio Resource Control (RRC) interface instance. All above signaling connections together manage the configuration and operation of DC. In FIG. 3A, the user plane connection between UPF and MN is Next Generation—User Plane (NG-U) (MN) interface instance, which corresponds to MN terminated bearer. In FIG. 3B, the user plane connection between UPF and SN is NG-U (SN) interface instance, which corresponds to SN terminated bearer. The user plane connection between MN and SN is Xn-User Plane (Xn-U) interface instance, which corresponds to split bearer. The user plane connection between MN and UE is Uu-User Plane (Uu-U) Master Cell Group (MCG) interface instance and the user plane connection between SN and UE is Uu-U Secondary Cell Group (SCG) interface instance. All above user plane connections together support the user data transfer of DC. From the perspective of the wireless communication network, the MN and the SN provide joint radio communication service to the same target UE. The MN may provide the radio communication service via local processing effort inside the MN and MCG resources over Uu-U (MCG) while the SN may provide the communication service in parallel via local processing effort inside the SN and SCG resources over Uu-U (SCG).

Aside from radio communication service, a MN may have local resources and capacities for non-radio-communication services such as computing, intelligence and storage towards a target UE. In case of resource/capacity insufficiency, the MN may turn to Cloud Resource Center (CRC) in upstream network node for help. The MN may not turn to the SN and needs no processing assistance from the SN. Likewise, a SN may also have local resources and capacities for non-radio-communication services towards the target UE. In case of resource/capacity insufficiency, the SN may turn to CRC in upstream network node for help. The SN may not turn to the MN and needs no processing assistance from the MN.

With more advanced and highly profiled services coming into play, such as intensified Mobile Edge Computing (MEC) tasks and applications involving massive data processing and lower latency requirement, the MN/SN may not have sufficient local resources for them; may encounter imbalanced local resources, incurring resource overload on one side but unused/idle on the other side; or cannot always turn to CRC in upstream network node for help because the long geographical and/or logical distance between the MN/SN and the CRC may fail to meet the lower latency requirement. the present disclosure introduces a new mechanism to enable two WANNs such as the MN and the SN to share their non-radio-communication service resources such as computing, intelligence and storage resources with each other in quicker and efficient way locally in lieu of involving upstream network node with higher latency. In this way, the WANNs can split their local work/tasks and provide joint non-radio-communication services to target UE(s).

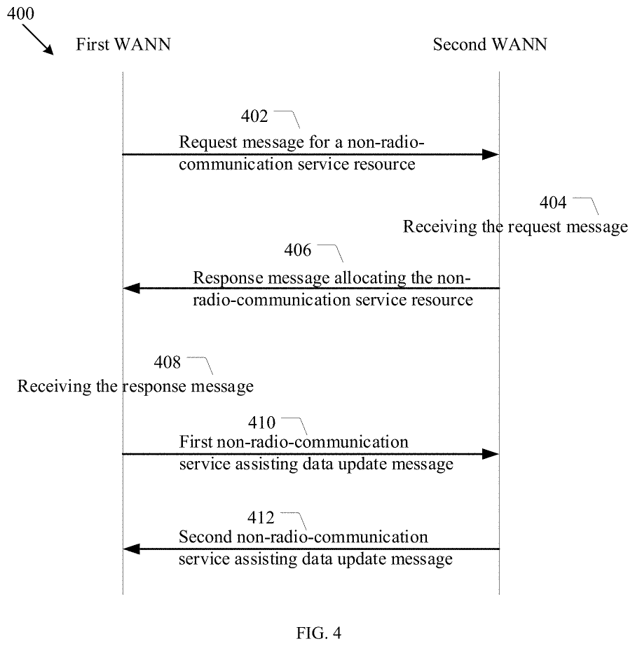

FIG. 4 illustrates an exemplary implementation 400 for jointly serving a UE such as the UE 106. The first WANN may transmit a request message for a non-radio-communication service resource of a second WANN to the second WANN (402). The first WANN may be, for example, the MN 104 or the SN 102 that is providing radio communication service for the UE 106. The first WANN may request the non-radio-communication service resource of the second WANN to assist to provide the non-radio-communication service to the UE 106. The first WANN may provide the UE 106 with a non-radio-communication service. The non-radio-communication service may include, for example, a computing assisting service, an intelligence assisting service, and a storage assisting service. The request message may include, for example, the type of non-radio-communication service and the amount of non-radio-communication service resource. Alternatively or additionally, the request message may include, for example, the identification of the UE for which the first WANN requests the non-radio-communication service resource to provide the non-radio-communication service.

The second WANN may receive the request message from the first WANN (404). The second WANN may or may not be providing the UE 106 with radio communication service. In an example, the second WANN may be the MN 104 or the SN 102 and the UE 106 may be in dual connectivity with the first WANN and the second WANN such that the first WANN and the second WANN may be providing joint radio communication service for the UE 106. In another example, the first WANN may be providing the UE 106 with radio communication service while the second WANN may be serving a UE other than the UE 106 though the second WANN may have spare non-radio-communication service resources to share with the first WANN.

Upon receiving the request message, the second WANN may determine if it would accept to allocate the requested non-radio-communication service resource based on the request message. For example, the second WANN may check if it has sufficient spare non-radio-communication service resources for sharing. Also, the second WANN may be more likely to accept the allocation request if the second WANN is providing radio communication service to the UE for which the non-radio-communication service resource is allocated to assist to provide the non-radio-communication service.

Where the second WANN determines to allocate the requested non-radio-communication service resource, the second WANN may transmit a response message allocating the requested non-radio-communication service resource to the first WANN (406). The response message may include an acknowledgement to allocate the non-radio-communication service. Alternatively or additionally, the response message may include further information with respect to the resource allocation of the non-radio-communication service. Where the second WANN determines not to allocate the requested non-radio-communication service resource, the second WANN may simply transmit a response message indicating to refuse the resource allocation request to the first WANN.

Upon receiving the response message allocating the requested non-radio-communication service resource for the UE 106 from the second WANN (408), the first WANN may, for example, split work/tasks for the non-radio-communication service provided to the UE 106. Then, the first WANN may transmit a first non-radio-communication service assisting data update message including a task of the non-radio-communication service to the second WANN (410). The task may include, for example, intermediate data for the computing service, training data for intelligence service, or storage data for storage service. The task may be included in the first non-radio-communication service assisting data update message in a form of container. The container is designated as an abstract communication block structure encapsulating the specific data to be transmitted. In the course of transmission, the WANN may not necessarily learn what is contained in the container and simply transmit or forward the container to specific target module as required.

When receiving the first non-radio-communication service assisting data update message including the task of the non-radio-communication service from the first WANN, the second WANN may complete the task of the non-radio-communication service using the non-radio-communication service resource allocated for the UE 106, and transmit a second non-radio-communication service assisting data update message including a result of the task to the first WANN (412). The result of the task may include, for example, the computing result from the intermediate data, the intelligence prediction result, or the indication of data store success/failure. The result of the task may be included in the second non-radio-communication service assisting data update message in a form of container. In this way, the first WANN and the second WANN may provide joint non-radio-communication service for the UE 106.

The request message, response message, and update message communicated between the first WANN and the second WANN may be carried by signaling. The signaling connection between the first WANN and the second WANN may be established through various existing or future communication interfaces between WANNs. The communication interfaces may include, for example, X2 Application Protocol (X2AP) between eNBs and Xn Application Protocol (XnAP) between gNBs. The signaling may be transported/transferred by Streaming Control Transport Protocol (SCTP) or General Packet Radio Services Tunnel Protocol (GTP-U). Alternatively, the signaling may be transported/transferred by other Transport Network Layer (TNL) protocols decoupling with the communication interfaces such as Transmission Control Protocol (TCP).

In some implementations, the first WANN may be neighboring to the second WANN, and the first WANN and the second WANN may have a direct communication interface in-between for information coordination such as signaling transmission/reception between the first WANN and the second WANN. The direct communication interface may be implemented in a wireline or wireless way. In this way, the first WANN may communicate with the second WANN more rapidly than the upstream network node such cloud resource center, and thus may jointly provide the non-radio-communication service to the served UE with much lower latency.

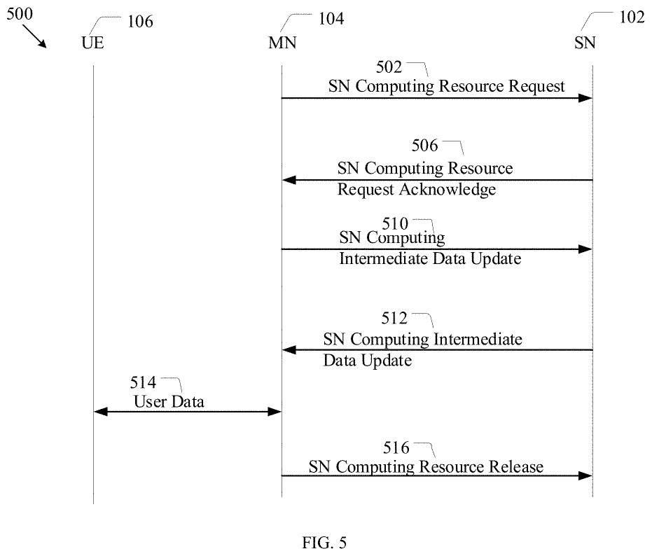

To further clarify the signaling procedure to accomplish the joint non-radio-communication service between the first WANN and the second WANN, various embodiments will be discussed with reference to FIGS. 5-10. The signaling procedures may be either UE associated or non-UE associated. In the case of UE associated, the signaling procedure may be intended to establish the joint non-radio-communication service dedicated to a specific UE, which has been already in DC/MC mode with joint radio communication service. In the case of non-UE associated, the signaling procedure may be intended to establish the joint non-radio-communication service commonly applied to a group of UEs, which are not yet in DC/MC mode without joint radio communication service.

FIG. 5 illustrates an exemplary implementation 500 for jointly providing a UE with the computing assisting service. In the implementation 500, the MN 104 and the SN 102 may be providing joint radio communication service for the UE 106 in a dual connectivity mode, for example, via separate MCG/SCG radio links over the air. In the meantime, the MN 104 may be providing a computing assistance service for the UE 106. The computing assistance service may represent any service providing the UE with various advanced computing capabilities including, for example, blockchain service, business analytics service, and collaborative editing service, etc. Where the local computing resources of the MN 104 are overloaded, the MN 104 may choose either to queue up all pending work/tasks (e.g. for high-profiled data services of UE) or to request other WANNs such as the SN 102 for computing assistance. In the case that the capability and quality of TNL signaling connection between the MN 104 and the SN 102 (e.g. SCTP) is good enough in terms of data transfer bandwidth, latency/jitters and reliability, the MN 104 may request the SN 102 to assist the MN 104 in the area of computing for its split-work/tasks.

The MN 104 may transmit “SN Computing Resource Request” message to the SN 102, which may include the information of requesting the SN 102 to allocate the expected computing resource and start the computing assistance operation if admitted (502). Upon receiving the “SN Computing Resource Request” message and accepting the request, the SN 102 may allocate the corresponding computing resources and provide the admitted capacity in the area of computing. Then, the SN 102 may transmit the “SN Computing Resource Request Acknowledge” message including the information related to the resource allocation of computing resources to the MN 104 (506). As such, the joint computing service between the MN 104 and the SN 102 may be established.

During the joint computing service, the MN 104 may transmit, for example, one or more “SN Computing Intermediate Data Update” messages including the relevant intermediate data information of split-work/tasks to the SN 102 (510). The relevant intermediate data information may include, for example, a blockchain transaction to be synchronized to a blockchain, business data for interactive visualization and analysis, and the like. The SN 102 may perform the corresponding computing assistance operation based on the intermediate data information. Then, the SN 102 may transmit the corresponding “SN Computing Intermediate Data Update” messages including the relevant data information of computing results to the MN 104 (512). The MN 104 may, for example, leverage the computing results from the SN 102 to compute the final result of the computing service for the UE 106. Then, the MN 104 may transmit the final result, i.e., user data obtained from the joint computing service and relevant processing by the MN 104 and the SN 102 to the UE 106 (514). It should be noted that the transmission between the MN 104 and the SN 102 may be achieved on control plane as signaling while the transmission between the MN 104 and the UE 106 may be achieved on user plane as user data.

When the MN 104 does not need the computing assistance from the SN 102, the MN 104 may transmit “SN Computing Resource Release” message to the SN 102, which may include the information of requesting the SN 102 to release/revoke the previously allocated computing resources (516). In response, the SN 102 may release and revoke the allocated storage resources to stop the computing assistance. Subsequent to the end of the joint non-radio-communication service between the MN 104 and the SN 102, the DC operation for the joint radio communication service between the MN 104 and the SN 102 may be kept ongoing if available.

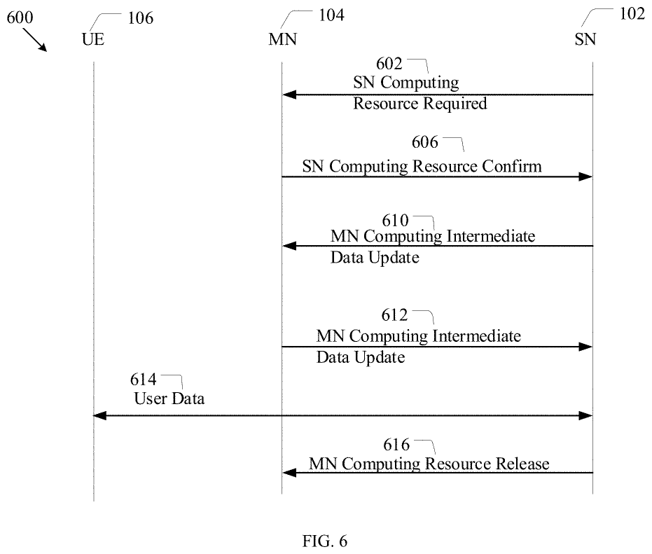

FIG. 6 illustrates an exemplary implementation 600 for jointly providing a UE with the computing assisting service. In the implementation 600, the MN 104 and the SN 102 may be providing joint radio communication service for the UE 106 in a dual connectivity mode, for example, via separate MCG/SCG radio links over the air. In the meantime, the SN 102 may be providing a computing assistance service for the UE 106. The computing assistance service may represent any service providing the UE with various advanced computing capabilities including, for example, blockchain service, business analytics service, and collaborative editing service, etc. Where the local computing resources of the SN 102 are overloaded, the SN 102 may choose either to queue up all pending work/tasks (e.g. for high-profiled data services of UE) or to request other WANNs such as the MN 104 for computing assistance. In the case that the capability and quality of TNL signaling connection between the MN 104 and the SN 102 (e.g. SCTP) is good enough in terms of data transfer bandwidth, latency/jitters and reliability, the SN 102 may request the MN 104 to assist the SN 102 in the area of computing for its split-work/tasks.

The SN 102 may transmit “SN Computing Resource Required” message to the MN 104, which may contain the information of requesting the MN 104 to allocate the expected computing resource and start the computing assistance operation if admitted (602). Upon receiving the “SN Computing Resource Required” message and accepting the request, the MN 104 may allocate the corresponding computing resources and provide the admitted capacity in the area of computing. Then, the MN 104 may transmit the “SN Computing Resource Confirm” message including the information related to the resource allocation of computing resources to the SN 102 (606). As such, the joint computing service between the SN 102 and the MN 104 may be established.

During the joint computing service, the SN 102 may transmit, for example, one or more “MN Computing Intermediate Data Update” messages including the relevant intermediate data information of split-work/tasks to the MN 104 (610). The relevant intermediate data information may include, for example, a blockchain transaction to be synchronized to a blockchain, business data for interactive visualization and analysis, and the like. The MN 104 may perform the corresponding computing assistance operation based on the intermediate data information. Then, the MN 104 may transmit the corresponding “MN Computing Intermediate Data Update” messages including the relevant data information of computing results to the SN 102 (612). The SN 102 may, for example, leverage the computing results from the MN 104 to obtain the final result of the computing service for the UE 106. Then, the SN 102 may transmit the final result, i.e., user data obtained from the joint computing service and relevant processing by the SN 102 and the MN 104 as user data to the UE 106 (614). It should be noted that the transmission between the MN 104 and the SN 102 may be achieved on control plane as signaling while the transmission between the SN 102 and the UE 106 may be achieved on user plane as user data.

When the SN 102 does not need the computing assistance from the MN 104, the SN 102 may transmit “MN Computing Resource Release” message to the MN 104, which may include the information of requesting the MN 104 to release/revoke the previously allocated computing resources (616). In response, the MN 104 may release and revoke the allocated computing resources to stop the computing assistance operation. Subsequent to the end of the joint non-radio-communication service between the MN 104 and the SN 102, the DC operation for the joint radio communication service between the MN 104 and the SN 102 may be kept ongoing if available.

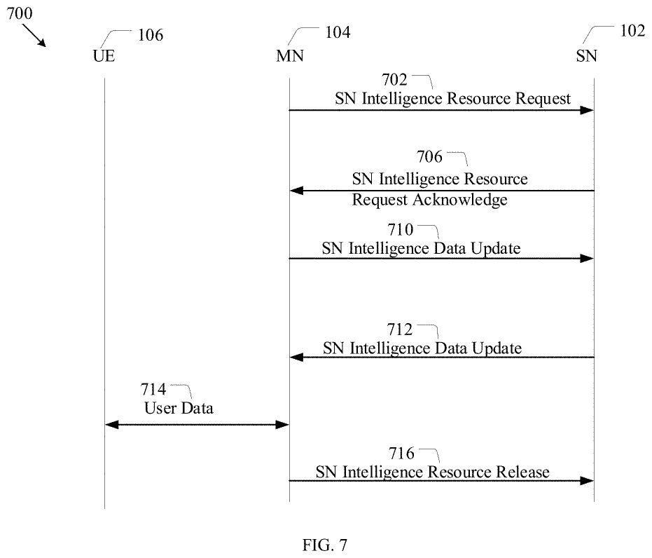

FIG. 7 illustrates an exemplary implementation 700 for jointly providing a UE with the intelligence assisting service. In the implementation 700, the MN 104 and the SN 102 may be providing joint radio communication service for the UE 106 in a dual connectivity mode, for example, via separate MCG/SCG radio links over the air. In the meantime, the MN 104 may be providing an intelligence assistance service for the UE 106. The intelligence assistance service may include, for example, natural language processing (NLP), speech recognition, autonomous driving or navigation, and the like. Where the local intelligence capabilities of the MN 104 are restricted, for example, the Deep Neural Network (DNN) parameter setting of Artificial Intelligence (AI) model is sub-optimal due to lack of sufficient training data, the MN 104 may choose either to await and collect additional training data from local serving cells (e.g., from various UEs served by MCG) or to request other WANNs such as the SN 102 for intelligence assistance. In the case that the capability and quality of TNL signaling connection between the MN 104 and the SN 102 (e.g. SCTP) is good enough in terms of data transfer bandwidth, latency/jitters and reliability, the MN 104 may request the SN 102 to assist the MN 104 in the area of intelligence assistance service. The SN 102 may provide additional training data to the MN 104 to facilitate to improve the AI intelligence model of the MN 104. Alternatively or additionally, the SN 102 may utilize its local AI intelligence model to assist to perform intelligence operation, for example, performing NLP on the text data received from the MN 104 or performing speech recognition on the audio data received from the MN 104.

The MN 104 may transmit “SN Intelligence Resource Request” message to the SN 102, which may include the information of requesting the SN 102 to allocate the expected intelligence resource and start the intelligence assistance operation if admitted (702). Upon receiving the “SN Intelligence Resource Request” message and accepting the request, the SN 102 may allocate the corresponding intelligence resources such as the local AI intelligence model of the SN 102 and the training data for improving the AI intelligence model of MN 104, thereby providing the admitted intelligence assistance service. Then, the SN 102 may transmit the “SN Intelligence Resource Request Acknowledge” message including information related to the resource allocation of intelligence resources to the MN 104 (706). As such, the joint intelligence service between the MN 104 and the SN 102 may be established.

During the joint intelligence service, the MN 104 may transmit, for example, one or more “SN intelligence Data Update” messages to the SN 102 (710). The “SN intelligence Data Update” messages may include, for example, related information on the training data that the MN 104 needs and/or the related data to be processed by the AI intelligence model of the SN 102, e.g. the text data for NLP and the audio data for speech recognition. The SN 102 may perform the corresponding intelligence assistance operation based on the information in the “SN intelligence Data Update” messages. Then, the MN 104 may transmit the corresponding “SN Intelligence Data Update” messages to the SN 102 (712). The corresponding “SN Intelligence Data Update” messages may include, for example, the expected training data and/or the prediction results produced by the AI intelligence model of the SN 102. The MN 104 may, for example, leverage the training data from the SN 102 to improve its own intelligence model and/or the prediction results from the SN 102 to obtain the final result of the intelligence service for the UE 106. The MN 104 may transmit the final result, i.e., user data obtained from the joint intelligence service and relevant processing by the MN 104 and the SN 102 as user data to the UE 106 (714).

When the MN 104 does not need the intelligence assistance from the SN 102, the MN 104 may transmit “SN Intelligence Resource Release” message to the SN 102, which may include the information of requesting the SN 102 to release/revoke the previously allocated intelligence resources (716). In response, the SN 102 may stop the intelligence assistance by releasing and revoking the allocated storage resources for the UE 106. Subsequent to the end of the joint non-radio-communication service between the MN 104 and the SN 102, the DC operation for the joint radio communication service between the MN 104 and the SN 102 may be kept ongoing if available.

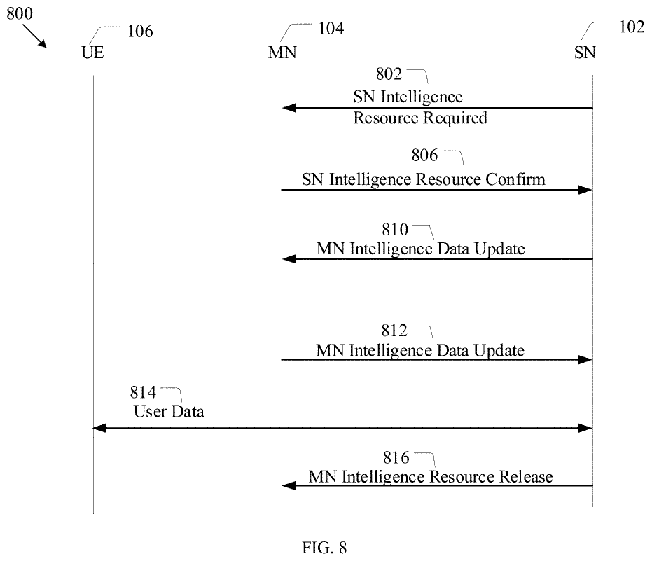

FIG. 8 illustrates an exemplary implementation 800 for jointly providing a UE with the intelligence assisting service. In the implementation 800, the SN 102 and the MN 104 may be providing joint radio communication service for the UE 106 in a dual connectivity mode, for example, via separate MCG/SCG radio links over the air. In the meantime, the SN 102 may be providing an intelligence assistance service for the UE 106. The intelligence assistance service may include, for example, natural language processing, speech recognition, autonomous driving or navigation, and the like. Where the local intelligence capabilities of the SN 102 are restricted, for example, the DNN parameter setting of AI model is sub-optimal due to lack of sufficient training data, the SN 102 may choose either to await and collect additional training data from local serving cells (e.g., from various UEs served by MCG) or to request other WANNs such as the MN 104 for intelligence assistance. In the case that the capability and quality of TNL signaling connection between the MN 104 and the SN 102 (e.g. SCTP) is good enough in terms of data transfer bandwidth, latency/jitters and reliability, the SN 102 may request the MN 104 to assist the SN 102 in the area of intelligence assistance service. The MN 104 may provide additional training data to the SN 102 to facilitate to train the AI intelligence model of the SN 102. Alternatively or additionally, the MN 104 may utilize its AI intelligence model to assist to perform prediction operation, for example, performing NLP on the text data received from the SN 102 or performing speech recognition on the audio data received from the SN 102.

The SN 102 may transmit “SN Intelligence Resource Required” message to the MN 104, which may include the information of requesting the MN 104 to allocate the expected intelligence resource and start the intelligence assistance operation if admitted (802). Upon receiving the “SN Intelligence Resource Required” message and accepting the request, the MN 104 may allocate the corresponding intelligence resources such as the local AI intelligence model of the MN 104 and the training data for training the AI intelligence model of SN 102, thereby providing the admitted intelligence assistance service. Then, the MN 104 may transmit the “SN Intelligence Resource Confirm” message including information related to the resource allocation of intelligence resources to the SN 102 (806). As such, the joint intelligence service between the MN 104 and the SN 102 may be established.

During the joint intelligence service, the SN 102 may transmit, for example, one or more “MN intelligence Data Update” messages to the MN 104 (810). The “MN intelligence Data Update” messages may include, for example, related information on the training data that the SN 102 expects and/or the related data to be processed by the AI intelligence model of the MN 104, e.g. the text data for NLP and the audio data for speech recognition. The MN 104 may perform the corresponding intelligence assistance operation based on the information in the “MN intelligence Data Update” messages. Then, the MN 104 may transmit the corresponding “MN Intelligence Data Update” messages to the SN 102 (812). The corresponding “MN Intelligence Data Update” messages may include, for example, the expected training data and/or the prediction results produced by the AI intelligence model of the MN 104. The SN 102 may, for example, leverage the training data from the MN 104 to improve its own intelligence model and/or the prediction results from the MN 104 to obtain the final result of the intelligence service for the UE 106. The SN 102 may transmit the final result, i.e., user data obtained from the joint intelligence service and relevant processing by the MN 104 and the SN 102 as user data to the UE 106 (814).

When the SN 102 does not need the intelligence assistance from the MN 104, the SN 102 may transmit “MN Intelligence Resource Release” message to the MN 104, which may include the information of requesting the MN 104 to release/revoke the previously allocated intelligence resources (816). In response, the MN 104 may stop the intelligence assistance by releasing and revoking the allocated intelligence resources. Subsequent to the end of the joint non-radio-communication service between the MN 104 and the SN 102, the DC operation for the joint radio communication service between the MN 104 and the SN 102 may be kept ongoing if available.

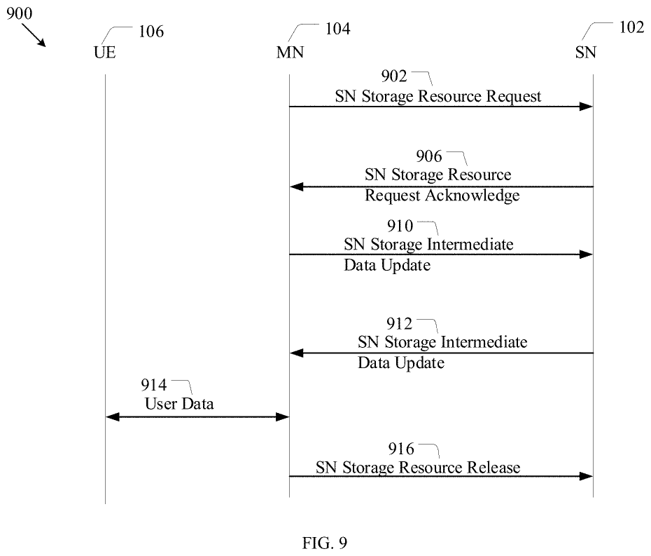

FIG. 9 illustrates an exemplary implementation 900 for jointly providing a UE with the storage assisting service. In the implementation 900, the MN 104 and the SN 102 may be providing joint radio communication service for the UE 106 in a dual connectivity mode, for example, via separate MCG/SCG radio links over the air. In the meantime, the MN 104 may be providing a storage assistance service for the UE 106. The storage assistance service may allow the UE 106 to store user data online, which eliminates the need for the UE to maintain a huge memory space locally. Where the local storage capacity of the MN 104 is limited, for example, due to large amount of data existing for MEC applications, the MN 104 may choose either to store those data in up-streamed cloud database or to request other WANNs such as the SN 102 for storage assistance. In the case that the capability and quality of TNL signaling connection between the MN 104 and the SN 102 (e.g. SCTP) is good enough in terms of data transfer bandwidth, latency/jitters and reliability, the MN 104 may request the SN 102 to assist the MN 104 in the area of storage.

The MN 104 may transmit “SN Storage Resource Request” message to the serving SN 102, which may include the information of requesting the SN 102 to allocate the expected storage resource and start the storage assistance operation if admitted (902). Upon receiving the “SN Storage Resource Request” message and accepting the request, the SN 102 may allocate the corresponding storage resources and provide the admitted capacity in the area of storage. Then, the SN 102 may transmit the “SN Computing Resource Request Acknowledge” message including the information related to the resource allocation of storage resources, e.g., the amount of allocated storage space, to the MN 104 (906). As such, the joint storage service between the MN 104 and the SN 102 may be established.

During the joint storage service, the MN 104 may transmit, for example, one or more “SN Storage Intermediate Data Update” to the SN 102 (910). The “SN Storage Intermediate Data Update” messages may include, for example, the relevant user data of the UE 106 to be stored online such as mobile edge multimedia cache data. The SN 102 may perform the corresponding storage assistance operation, for example, utilizing the allocated storage space to store the user data of the UE 106. Then, the SN 102 may transmit the corresponding “SN Storage Intermediate Data Update” messages including the relevant information of data store operation result, e.g., data store success or failure, to the MN 104 (912). The MN 104 may notify the UE 106 of the result of the data store operation (914). In some implementations, where the MN 104 obtain sufficient free storage resources, the SN 102 may transfer the stored user data of the UE 106 back to the MN 104 for storage through the “SN Storage Intermediate Data Update” messages.

When the MN 104 does not need the storage assistance from the SN 102, the MN 104 may transmit “SN Storage Resource Release” message to the SN 102, which may include the information of requesting the SN 102 to release/revoke the previously allocated storage resources (916). In response, the SN 102 may stop the storage assistance by releasing and revoking the allocated storage resources. Subsequent to the end of the joint storage service between the MN 104 and the SN 102, the DC operation for the joint radio communication service between the MN 104 and the SN 102 may be kept ongoing if available.

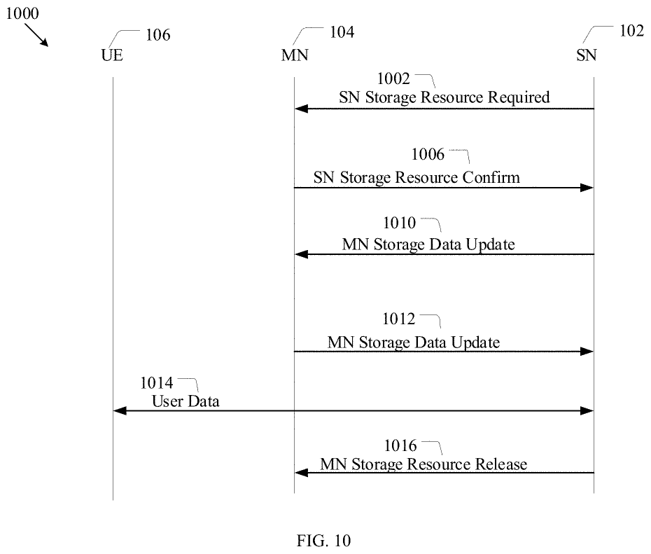

FIG. 10 illustrates an exemplary implementation 1000 for jointly providing a UE with the storage assisting service. In the implementation 1000, the SN 102 and the MN 104 may be providing joint radio communication service for the UE 106 in a dual connectivity mode, for example, via separate MCG/SCG radio links over the air. In the meantime, the SN 102 may be providing a storage assistance service for the UE 106. The storage assistance service may allow the UE 106 to store user data online, which eliminates the need for the UE to maintain a huge memory space locally. Where the local storage capacity of the SN 102 is limited, for example, due to large amount of data existing for MEC applications, the SN 102 may choose either to store those data in up-streamed cloud database or to request other WANNs such as the MN 104 for storage assistance. In the case that the capability and quality of TNL signaling connection between the MN 104 and the SN 102 (e.g. SCTP) is good enough in terms of data transfer bandwidth, latency/jitters and reliability, the SN 102 may request the MN 104 to assist the SN 102 in the area of storage.

The SN 102 may transmit “SN Storage Resource Required” message to the MN 104, which may contain the information of requesting the MN 104 to allocate the expected storage resource and start the storage assistance operation if admitted (1002). Upon receiving the “SN Storage Resource Required” message and accepting the request, the MN 104 may allocate the corresponding storage resources and provide the admitted capacity in the area of storage. Then, the MN 104 may transmit the “SN Storage Resource confirmed” message including the information related to the resource allocation of storage resources, e.g., the amount of allocated storage resources, to the SN 102 (906). As such, the joint storage service between the MN 104 and the SN 102 may be established.

During the joint storage service, the SN 102 may transmit, for example, one or more “MN Storage Intermediate Data Update” messages to the MN 104 (1010). The “SN Storage Intermediate Data Update” messages may include, for example, the relevant user data of the UE 106 to be stored online such as mobile edge multimedia cache data. The MN 104 may perform the corresponding storage assistance operation, for example, utilizing the allocated storage resources to store the user data of the UE 106. Then, the MN 104 may transmit the corresponding “MN Storage Data Update” messages including the relevant information of data store operation result, e.g., data store success or failure, to the SN 102 (1012). The SN 102 may notify the UE 106 of the result of the data store operation (1014).

When the SN 102 does not need the storage assistance from the MN 104, the SN 102 may transmit “MN Storage Resource Release” message to the MN 104, which may include the information of requesting the MN 104 to release/revoke the previously allocated storage resources (1016). In response, the MN 104 may stop the storage assistance by releasing and revoking the allocated storage resources. Subsequent to the end of the joint non-radio-communication service between the MN 104 and the SN 102, the DC operation for the joint radio communication service between the MN 104 and the SN 102 may be kept ongoing if available.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method performed by a first wireless access network node serving a user equipment in a wireless communication network, comprising:
transmitting a request message for a non-radio-communication service resource of a second wireless access network node to the second wireless access network node, the first wireless access network node providing the user equipment with a non-radio-communication service and requesting the non-radio-communication service resource to assist to provide the non-radio-communication service to the user equipment; and
receiving a response message allocating the non-radio-communication service resource for the user equipment from the second wireless access network node.

2. The method of claim 1, wherein the user equipment is in a dual connectivity with the first wireless access network node and the second wireless access network node such that the first wireless access network node and the second wireless access network node provide joint radio communication service to the user equipment.

3. The method of claim 2, wherein in the dual connectivity, the first wireless access network node is a master node and the second wireless access network node is a secondary node, or the first wireless access network node is a secondary node and the second wireless access network node is a master node.

4. The method of claim 1, wherein the first wireless access network node is neighboring to the second wireless access network node, and the first wireless access network node and the second wireless access network node have a direct communication interface in-between for information coordination.

5. The method of claim 1, wherein the method further comprises:
in response to receiving the response message, transmitting a first non-radio-communication service assisting data update message including a task of the non-radio-communication service to the second wireless access network node.

6. The method of claim 5, wherein the method further comprises:
receiving a second non-radio-communication service assisting data update message including a result of the task from the second wireless access network node.

7. The method of claim 6, wherein the task is included in the first non-radio-communication service assisting data update message in a form of container and the result of the task is included in the second non-radio-communication service assisting data update message in a form of container.

8. The method of claim 1, wherein the method further comprises:
transmitting a non-radio-communication service resource release message to the second wireless access network node such that the second wireless access network node releases and revokes the non-radio-communication service resource allocated for the user equipment to end a joint non-radio-communication service between the first wireless access network node and the second wireless access network node, wherein a dual connectivity operation for a joint radio communication service between the first wireless access network node and the second wireless access network node can be kept subsequent to the end of the joint non-radio-communication service.

9. The method of claim 1, wherein the non-radio-communication service comprises at least one of a computing assisting service, an intelligence assisting service, or a storage assisting service.

10. The method of claim 1, the method further comprises transmitting a user data resulted from a joint non-radio-communication service and relevant processing by the first wireless access network node and the second wireless access network node to the user equipment.

11. A method performed by a second wireless access network node in a wireless communication network, comprising:
receiving a request message for a non-radio-communication service resource of the second wireless access network node from a first wireless access network node, the first wireless access network node providing a user equipment with both a radio communication service and a non-radio-communication service and requesting the non-radio-communication service resource to assist to provide the non-radio-communication service to the user equipment; and
transmitting a response message allocating the non-radio-communication service resource to the first wireless access network node.

12. The method of claim 11, wherein the user equipment is in a dual connectivity with the first wireless access network node and the second wireless access network node such that the first wireless access network node and the second wireless access network node provide joint radio communication service to the user equipment.

13. The method of claim 11, wherein the method further comprises allocating the non-radio-communication service resource for the user equipment.

14. The method of claim 11, wherein the method further comprises:
in response to receiving a first non-radio-communication service assisting data update message including a task of the non-radio-communication service from the first wireless access network node,
completing the task of the non-radio-communication service using the non-radio-communication service resource allocated for the user equipment, and
transmitting a second non-radio-communication service assisting data update message including a result of the task to the first wireless access network node.

15. The method of claim 11, wherein the method further comprises:
in response to receiving a non-radio-communication service resource release message from the first wireless access network node, releasing and revoking the non-radio-communication service resource allocated for the user equipment to end a joint non-radio-communication service between the first wireless access network node and the second wireless access network node, wherein a dual connectivity operation for a joint radio communication service between the first wireless access network node and the second wireless access network node can be kept subsequent to the end of the joint non-radio-communication service.

16. A device, comprising:
a memory operable to store computer-readable instructions; and
a processor circuitry operable to read the computer-readable instructions, the processor circuitry when executing the computer-readable instructions is configured to:
transmit, from a first wireless access network node serving a user equipment in a wireless communication network, a request message for a non-radio-communication service resource of a second wireless access network node to the second wireless access network node, the first wireless access network node providing the user equipment with a non-radio-communication service and requesting the non-radio-communication service resource to assist to provide the non-radio-communication service to the user equipment; and
receive a response message allocating the non-radio-communication service resource for the user equipment from the second wireless access network node.

17. The device of claim 16, wherein the user equipment is in a dual connectivity with the first wireless access network node and the second wireless access network node such that the first wireless access network node and the second wireless access network node provide joint radio communication service to the user equipment.

18. The device of claim 16, wherein the first wireless access network node is neighboring to the second wireless access network node, and the first wireless access network node and the second wireless access network node have a direct communication interface in-between for information coordination.

19. The device of claim 16, wherein the processor circuitry is further configured to:
in response to receiving the response message, transmit a first non-radio-communication service assisting data update message including a task of the non-radio-communication service to the second wireless access network node.

20. The device of claim 16, wherein the processor circuitry is further configured to:
transmit a non-radio-communication service resource release message to the second wireless access network node such that the second wireless access network node releases and revokes the non-radio-communication service resource allocated for the user equipment to end a joint non-radio-communication service between the first wireless access network node and the second wireless access network node, wherein a dual connectivity operation for a joint radio communication service between the first wireless access network node and the second wireless access network node can be kept subsequent to the end of the joint non-radio-communication service.
